(19) United States
(12) Patent Application Publication
(10) Pub. No.: US 2018/0175702 A1
(43) Pub. Date: Jun. 21, 2018

(54) MOTOR SHAFT SYSTEM WITH A COOLING FUNCTION

(71) Applicant: Industrial Technology Research Institute, Chulung (TW)

(72) Inventors: Ping-Lun LI, Chutung (TW); Li-Song LIN, Chutung (TW)

(21) Appl. No.: 15/386,350

(22) Filed: Dec. 21, 2016

(30) Foreign Application Priority Data
Dec. 16, 2016 (TW) 105141792

(51) Int. Cl. H02K 9/06; H02K 5/18

(52) U.S. Cl. CPC H02K 9/06; H02K 5/18

(57) ABSTRACT

A motor shaft system with a cooling function is provided, the motor shaft system has: a motor housing; a stator located on an inner wall of the motor housing; a shaft located in the motor housing, wherein the shaft comprises a plurality of through holes, one of the plurality of through holes penetrates from a first end of the shaft to a second end of the shaft along an axial direction of the shaft; a bearing located on the motor housing, wherein the bearing is configured to support the shaft; and a rotor located on the shaft, wherein there is a gap between the rotor and the stator.

### CROSS REFERENCE TO RELATED APPLICATION

This application claims the priority benefits of Taiwan application No. 105141792, entitled “MOTOR SHAFT SYSTEM WITH A COOLING FUNCTION”, and filed on Dec. 16, 2016. The entirety of which is incorporated by reference.

### TECHNICAL FIELD

The disclosure relates to a motor shaft system with a cooling function.

### BACKGROUND

In order to develop power systems of electric vehicles toward the high density of output power, enhancement for the heat dissipation ability of motors is one of key technologies. However, due to the rotation characteristics in a motor system, the heat of rotors is dissipated only through the conduction of internal air circulation and the conduction of bearings. In some of motors which generate a large amount of heat (such as induction motors), the heat dissipation of rotors become more severe. Recently, motors of some electric buses also encounter an overheating problem because it is not easy for the rotors to dissipate heat. The rotors may encounter the overheating problem when operating at a maximum power point. In another type of motors such as belt starter generator (BSG), the problems of overheating and heat sinks still exist. Therefore, structural strength of shafts shall also be taken into consideration. It is necessary to establish a high efficiency cooling system for motors to solve the aforesaid problems.

### SUMMARY

The present disclosure provides a motor shaft system with a cooling function. In an embodiment, the motor shaft system comprises: a motor housing; a stator located on an inner wall of the motor housing; a shaft located in the motor housing, wherein the shaft comprises a plurality of through holes, and one of the plurality of through holes penetrates from a first end of the shaft to a second end of the shaft along an axial direction of the shaft; a bearing located on the motor housing, wherein the bearing is configured to support the shaft; and a rotor located on the shaft, wherein there is a gap between the rotor and the stator.

The present disclosure provides a motor shaft system with a cooling function. In an embodiment, the motor shaft system comprises: a motor housing; a stator located on an inner wall of the motor housing; a shaft located in the motor housing, wherein the shaft comprises at least one gas flow channel, the at least one gas flow channel penetrates from a first end of the shaft to a second end of the shaft along an axial direction of the shaft; a bearing located on the motor housing, wherein the bearing is configured to support the shaft; and a rotor located on the shaft, wherein there is a gap between the rotor and the stator.

The foregoing will become better understood from a careful reading of a detailed description provided herein below with appropriate reference to the accompanying drawings.

### BRIEF DESCRIPTION OF THE DRAWINGS

FIG. 1 is a cross-sectional view illustrating a motor in accordance with an embodiment of the present disclosure.

FIG. 2 is a diagram illustrating a motor in accordance with an embodiment of the present disclosure.

FIG. 3 is a diagram illustrating the shaft of FIG. 1 in accordance with an embodiment of the present disclosure.

FIG. 4 is a graph of broken lines illustrating deformation of shafts in accordance with an embodiment of the present disclosure.

FIG. 5 is a diagram illustrating through holes of shafts in accordance with embodiments of the present disclosure.

FIG. 6 is a cross-sectional view illustrating a motor in accordance with an embodiment of the present disclosure.

### DETAILED DESCRIPTION OF DISCLOSED EMBODIMENTS

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

The present disclosure utilizes double centrifugal fans to produce a jet air or gas flow directly penetrating through a body of a shaft. The shaft has through holes or gas flow channels in its body. The through holes may have geometry shapes such as a honeycomb structure. The jet air or gas flow cools down the rotors of motors so as to solve problems of heat dissipation.

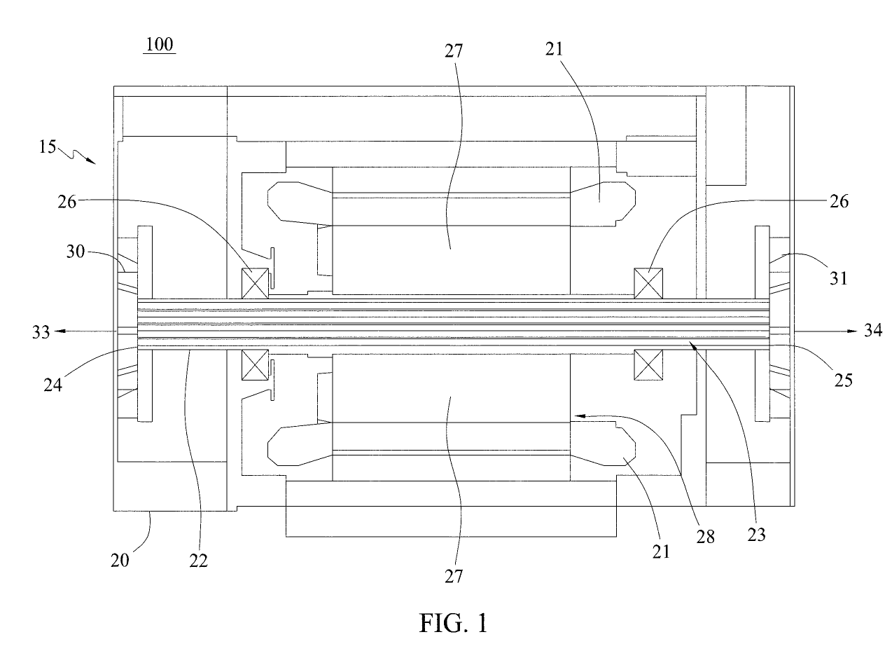

FIG. 1 is a cross-sectional view illustrating a motor 100 in accordance with an embodiment of the present disclosure. In the embodiment, a motor shaft system 15 with a cooling function. The motor shaft system 15 comprises: a motor housing 20; a stator 21 located on an inner wall of the motor housing 20; a shaft 22 located in the motor housing 20, wherein the shaft 22 comprises a plurality of through holes 23, one of the plurality of through holes 23 penetrates from a first end 24 of the shaft 22 to a second end 25 of the shaft 22 along an axial direction of the shaft 22; a bearing 26 located on the motor housing 20, wherein the bearing 26 is configured to support the shaft 22; and a rotor 27 located on the shaft 22, wherein there is a gap 28 between the rotor 27 and the stator 21. In an embodiment, the plurality of through holes 23 are separated, and they are not joined to one another.

The stator 21 is mainly made of a stator core and a coil winding (not shown). The stator 21 is located on an inner wall of the motor housing 20. The rotor 27 is mainly made of a rotor core (a magnetic pole or a magnetic choke) and a coil winding (not shown). The rotor 27 encircles the shaft 22. The motor 100 is mainly formed by assembling the bearing 26, the stator 21, the rotor 27, and the motor housing 20 so that the rotor 27 rotates in the stator 21.

In an embodiment, the motor shaft system 15 further comprises a first centrifugal fan 30 located at the first end 24 of the shaft 22; and a second centrifugal fan 31 located at the second end 25 of the shaft 22. An axial direction 33 of the first centrifugal fan 30 is opposite to an axial direction 34 of the second centrifugal fan 31. In other words, the first centrifugal fan 30 is installed and fixed at the first end 24 of the shaft 22. The second centrifugal fan 31 is installed and fixed at the second end 25 of the shaft 22. Therefore, the shaft 22, the first centrifugal fan 30, and the second centrifugal fan 31 have the same rotational direction when operating.

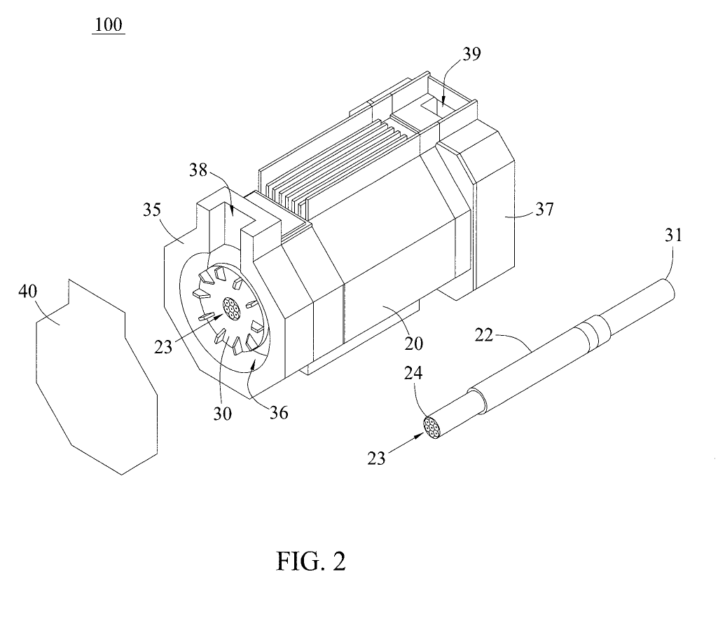

FIG. 2 is a diagram illustrating a motor 100 in accordance with an embodiment of the present disclosure. In the embodiment, the motor shaft system 15 further comprises a first volute 35 located on a side of the motor housing 20. The first volute 35 is adjacent to the first end 24 of the shaft 22. There is an air space 36 between the first volute 35 and the first end 24 of the shaft 22.

In an embodiment, the motor shaft system 15 further comprises a second volute 37 located on another side of the motor housing 20. The second volute 37 is adjacent to the second end 25. There is an air space between the second volute 37 and the second end 25. In an embodiment, the first volute 35 has an outlet 38 for exhaust. The second volute 37 has an inlet 39. The first volute 35 has a seal casing 40, wherein the seal casing 40 covers the side of the motor housing 20. Therefore, the air space 36 is formed between the first volute 35 and the first centrifugal fan 30.

The first end 24 of the shaft 22 is aligned with the center of the first centrifugal fan 30. The shaft 22 has a plurality of through holes 23. In practice, the first centrifugal fan 30 and the second centrifugal fan 31 are rotating synchronously with the shaft 22. The first centrifugal fan 30 and the second centrifugal fan 31 are capable of propelling air or gas flows and generating a jet air or gas flow as the shaft 22 rotates. The air or gas enters the second volute 37 through the inlet 39, wherein the air or gas is sucked into the second volute 37. Further, the second centrifugal fan 31 introduces the air or gas into the through holes 23 of the shaft 22. The first centrifugal fan 30 then extracts the air or gas from the plurality of through holes 23. The air or gas is exhausted from the first volute 35 through the outlet 38. The first centrifugal fan 30 and the second centrifugal fan 31 supply motive force to the air or gas. When the air or gas passes through the through holes 23, the thermal energy of the rotor 27 is remove so as to cool down the rotor 27.

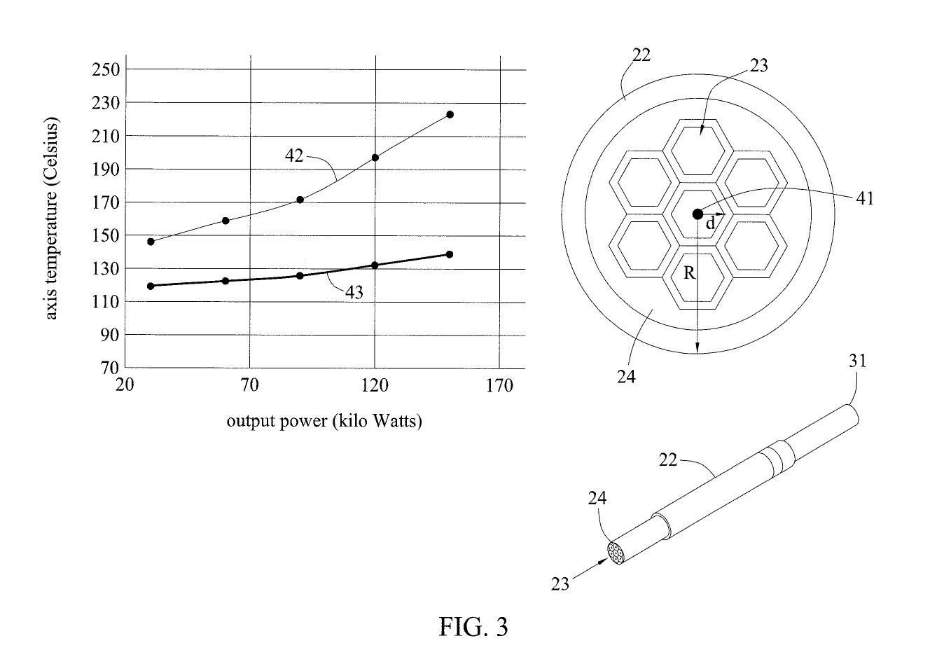

FIG. 3 is a diagram illustrating the shaft 22 in accordance with an embodiment of the present disclosure. In the embodiment, the through holes 23 are shaping up to be hexagonal through holes. Shapes of the through holes 23 are hexagonal at the first end 24 and the second end 25. In addition, the through holes 23 are stacked one another. The shapes of the through holes 23 are in a honeycomb arrangement at the first end 24 and the second end 25. In an embodiment, a length d is measured from a center 41 of each of the through holes 23 to any apex. The shaft 22 has an outer diameter R. When the length d is 15%-20% of the outer diameter R of the shaft 22, the rotor 27 achieves a better cooling effect.

A broken line 42 describes a relationship of axis temperatures (Celsius) at different output powers (kilo Watts) of a motor with a solid shaft. As the output power increases, the axis temperature of the solid shaft also increases. A broken line 43 describes a relationship of axis temperatures (Celsius) at different output power (kilo Watts) of a motor with the shaft 22. The shaft 22 has the through holes 23 arranged in a honeycomb arrangement. At any output power of motors, the axis temperature of the shaft 22 is lower than that of the solid shaft. For example, when the output power of the motor is 160 kW, the axis temperature of the shaft 22 is about 140 degrees. The axis temperature of the solid shaft is about 220 degrees. As a whole, the axis temperature of the shaft 22 is about 20%-30% lower than that of the solid shaft.

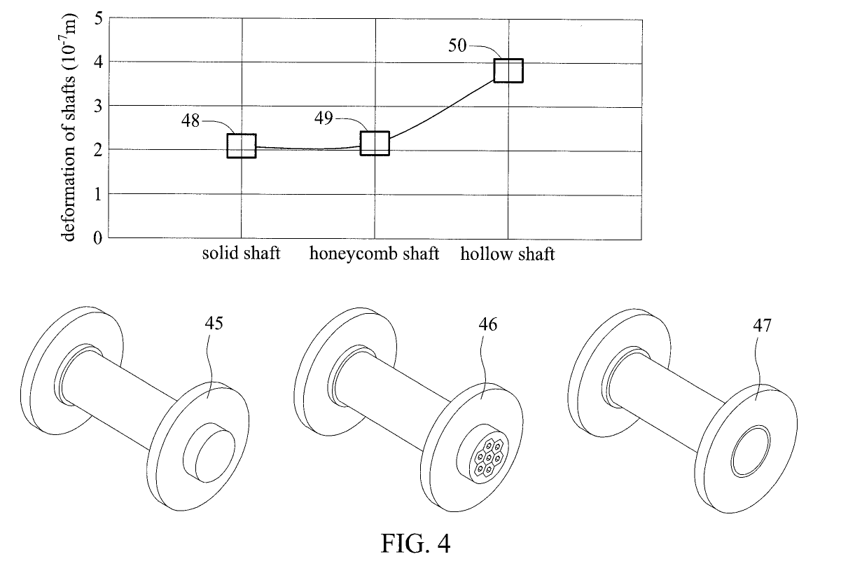

FIG. 4 is a graph of broken lines illustrating deformation of shafts in accordance with an embodiment of the present disclosure. It assumes that the same rotational speed and the same load torque are given to those shafts. It also assumes that the shafts have been operated for a specific period. A point 48 represents that an amount of deformation of a solid shaft 45 is 2.09*10⁻⁷ m. A point 49 represents that an amount of deformation of a honeycomb shaft 46 is 2.17*10⁻⁷ m. A point 50 represents that an amount of deformation of a hollow shaft 47 is 3.8*10⁻⁷ m. The deformation of the honeycomb shaft 46 is close to that of the solid shaft 45. Therefore, the honeycomb shaft 46 has a structural strength or rigidity close to that of the solid shaft 45. In comparison with the hollow shaft 47 having a similar heat radiating area, the deformation of the honeycomb shaft 46 has been reduced by 96%. It may be shown that the honeycomb shaft 46 not only has a structural strength close to that of the solid shaft 45, but also reduces its axial temperature since the honeycomb shaft 46 has larger contact area.

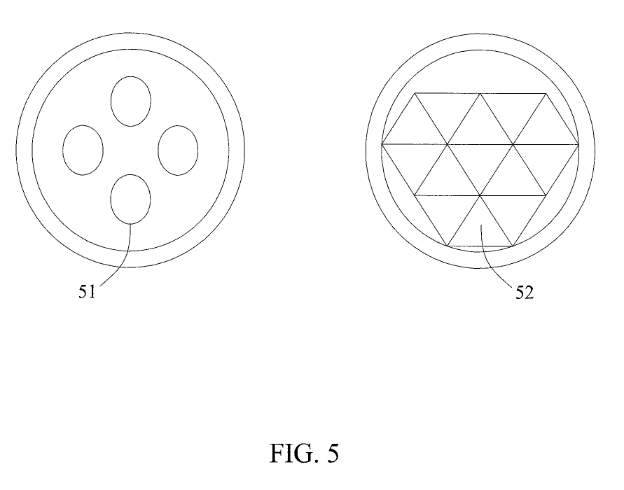

FIG. 5 is a diagram illustrating through holes of the shafts in accordance with embodiments of the present disclosure. In an embodiment, the through holes 23 of the shaft 22 are circular through holes 51. Shapes of the through holes 23 are circular at the first end 24 and the second end 25. In an embodiment, the through holes 23 of the shaft 22 are triangular through holes 52. Shapes of the through holes 23 are triangular at the first end 24 and the second end 25.

In an embodiment, the through holes 23 of the shaft 22 are formed by a metal drilling process. The metal drilling process drills from the first end 24 to the second end 25 so that air or gas may pass through the through holes 23 of the shaft 22.

In an embodiment for manufacturing the shaft 22, a solid shaft is lathed, milled, or punched into a hollow shaft. Metal plates are stamped into a honeycomb structure with a long columnar shape or a triangular structure with a long columnar shape (for example, a metal honeycomb structure of a catalyst converter). Later, the honeycomb structure or the triangular structure is placed and fixed in the hollow shaft. A shaft 22 having a plurality of through holes 23 is obtained.

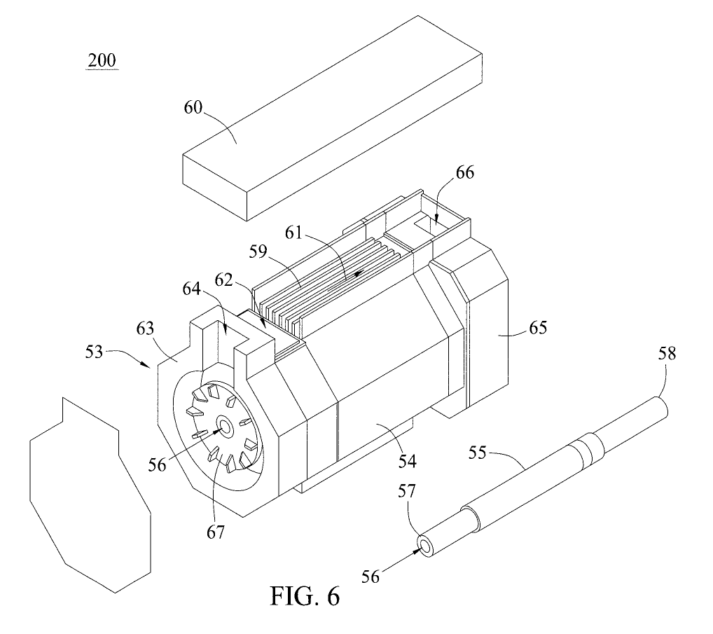

FIG. 6 is a cross-sectional view illustrating a motor 200 in accordance with an embodiment of the present disclosure. In the embodiment, a motor shaft system 53 with a cooling function is provided, and the motor shaft system 53 comprises: a motor housing 54; a stator (similar to the stator 21) located on an inner wall of the motor housing 54; a shaft 55 located in the motor housing 54, wherein the shaft 55 comprises at least one gas flow channel 56, the at least one gas flow channel 56 penetrates from a first end 57 of the shaft 55 to a second end 58 of the shaft 55 along an axial direction of the shaft 55; a bearing (similar to the bearing 26) located on the motor housing 54, wherein the bearing is configured to support the shaft 55; and a rotor (similar to the rotor 27) located on the shaft 55, wherein there is a gap between the rotor and the stator. The at least one gas flow channel 56 allows the gases or the air to pass through.

In an embodiment, the motor housing 54 further comprises a heat dissipation fin 59. The heat dissipation fin 59 is located on an outer wall of the motor housing 54, and the stator is surrounded by the heat dissipation fin 59. In other words, the heat dissipation fin 59 is adjacent to the stator and is located on an opposite side to the stator. In an embodiment, the motor shaft system 53 further comprises a cover plate 60 connected to the motor housing 54. The cover plate 60 covers the heat dissipation fin 59. There is a gas flow channel 61 between the cover plate 60 and the motor housing 54. The cover plate 60 comprises an inlet 62, and the inlet 62 of the cover plate 60 joins the gas flow channel 61. The gas flow channel 61 allows the gases or the air to pass through.

In an embodiment, the motor shaft system 53 further comprises a first volute 63 located on a side of the motor housing 54. The first volute 63 comprises an outlet 64. The motor shaft system 53 further comprises a second volute 65 located on another side of the motor housing 54. The second volute 65 comprises an inlet 66 joined with the gas flow channel 61.

In an embodiment, the motor shaft system 53 further comprises a first centrifugal fan 67 located at the first end 57; and a second centrifugal fan (in the second volute 65) located at the second end 58. An axial direction of the first centrifugal fan 67 is opposite to an axial direction of the second centrifugal fan.

In practice, the shaft 22 drives the first centrifugal fan 67 and the second centrifugal fan. Thus, the first centrifugal fan 67 and the second centrifugal fan rotate and generate a jet air or gas flow. The air or gas enters through the inlet 62. The air or gas flows through the heat dissipation fin 59 and the gas flow channel 61. Later, the air or gas enters through the inlet 66. The second centrifugal fan introduces the air or gas into the at least one gas flow channel 56 of the shaft 55, wherein the air or gas enters from the second end 58 to the first end 57. The first centrifugal fan 67 then extracts the air or gas from the at least one gas flow channel 56. The air or gas is exhausted from the outlet 64 of the first volute 63. Therefore, the first centrifugal fan 67 and the second centrifugal fan supply motive force to the air or gas. When the air or gas passes through the heat dissipation fin 59, the thermal energy of the stator is taken away so that the stator is cooling down. In addition, when the air or gas passes through the at least one gas flow channel 56 of the shaft 55, the thermal energy of the rotor is removed so as to cool down the rotor. Therefore, the motor shaft system 53 is capable of simultaneously dissipating the rotor and the stator.

In an embodiment, the present disclosure relates to a motor shaft system with a cooling function. Two centrifugal fans are synchronized with a shaft and generate a jet air or gas flow. The jet air or gas flow passes through heat dissipation fins so as to take away the thermal energy of a stator (a secondary heat dissipation path). The jet air or gas flow then passes through holes of the shaft, wherein the shaft has through holes with a honeycomb structure, circular through holes, or triangular through holes. The honeycomb structure, the circular through holes, or the triangular through holes are considered as a heat exchange region (a main heat dissipation path). The through holes of the shaft are capable of dissipating heat of the rotor via the jet air or gas flow. Meanwhile, the structural strength of the shaft still remains.

It will be apparent to those skilled in the art that various modifications and variations can be made to the disclosed embodiments. It is intended that the specification and examples be considered as exemplary embodiments only, with a scope of the disclosure being indicated by the following claims and their equivalents.

What is claimed is:

1. A motor shaft system with a cooling function, the motor shaft system comprising:
a motor housing;
a stator located on an inner wall of the motor housing;
a shaft located in the motor housing, wherein the shaft comprises a plurality of through holes, one of the plurality of through holes penetrates from a first end of the shaft to a second end of the shaft along an axial direction of the shaft;
a bearing located on the motor housing, wherein the bearing is configured to support the shaft; and
a rotor located on the shaft, wherein there is a gap between the rotor and the stator.

2. The motor shaft system with a cooling function according to claim 1, wherein the plurality of through holes are not joined to one another.

3. The motor shaft system with a cooling function according to claim 1, wherein the plurality of through holes are circular through holes, and shapes of the plurality of through holes are circular at the first end and the second end.

4. The motor shaft system with a cooling function according to claim 1, wherein the plurality of through holes are hexagonal through holes, and shapes of the plurality of through holes are hexagonal at the first end and the second end.

5. The motor shaft system with a cooling function according to claim 4, wherein the plurality of through holes are stacked each other, and shapes of the plurality of through holes are in a honeycomb arrangement at the first end and the second end.

6. The motor shaft system with a cooling function according to claim 1, wherein the plurality of through holes are triangular through holes, and shapes of the plurality of through holes are triangular at the first end and the second end.

7. The motor shaft system with a cooling function according to claim 1, further comprising:
a first centrifugal fan located at the first end; and
a second centrifugal fan located at the second end.

8. The motor shaft system with a cooling function according to claim 7, wherein an axial direction of the first centrifugal fan is opposite to an axial direction of the second centrifugal fan.

9. The motor shaft system with a cooling function according to claim 1, further comprising:
a first volute located on a side of the motor housing, wherein the first volute is adjacent to the first end, and there is a first air space between the first volute and the first end; and
a second volute located on another side of the motor housing, wherein the second volute is adjacent to the second end, and there is a second air space between the second volute and the second end.

10. The motor shaft system with a cooling function according to claim 9, wherein the first volute comprises an outlet, and the second volute comprises an inlet.

11. A motor shaft system with a cooling function, comprising:
a motor housing;
a stator located on an inner wall of the motor housing;
a shaft located in the motor housing, wherein the shaft comprises at least one gas flow channel, the at least one gas flow channel penetrates from a first end of the shaft to a second end of the shaft along an axial direction of the shaft;
a bearing located on the motor housing, wherein the bearing is configured to support the shaft; and
a rotor located on the shaft, wherein there is a gap between the rotor and the stator.

12. The motor shaft system with a cooling function according to claim 11, further comprising:
a first volute located on a side of the motor housing, wherein the first volute comprises an outlet.

13. The motor shaft system with a cooling function according to claim 11, wherein the motor housing comprises a heat dissipation fin, and the heat dissipation fin is located on an outer wall of the motor housing and the stator is surrounded by the heat dissipation fin.

14. The motor shaft system with a cooling function according to claim 13, further comprising:
a cover plate connected to the motor housing, wherein the cover plate covers the heat dissipation fin, and there is a gas flow channel between the cover plate and the motor housing, and the cover plate comprises an inlet, and the inlet of the cover plate joins the gas flow channel.

15. The motor shaft system with a cooling function according to claim 14, further comprising:
a second volute located on another side of the motor housing, wherein the second volute comprises an inlet joined to the gas flow channel.

16. The motor shaft system with a cooling function according to claim 11, further comprising:
a first centrifugal fan located at the first end; and
a second centrifugal fan located at the second end.

17. The motor shaft system with a cooling function according to claim 16, wherein an axial direction of the first centrifugal fan is opposite to an axial direction of the second centrifugal fan.
